(19) United States
(12) Patent Application Publication
(10) Pub. No.: US 2009/0233199 A1
(43) Pub. Date: Sep. 17, 2009

(54) GLOSS CONTROL PARTICLE, DEVELOPER SET, AND IMAGE FORMING METHOD

(76) Inventors: Chiyoshi NOZAKI, Otsu-shi (JP); Yoshimichi Ishikawa, Itami-shi (JP); Atsushi Yamamoto, Kawanishi-shi (JP); Takuya Kadota, Kobe-shi (JP); Tsuyoshi Nozaki, Osaka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/402,710

(22) Filed: Mar. 12, 2009

(30) Foreign Application Priority Data
Mar. 12, 2008 (JP) 2008-061979

(51) Int. Cl. G03G 9/087; G03G 9/097; G03G 9/10; G03G 13/20

(52) U.S. Cl. 430/107.1; 430/108.2; 430/109.4; 430/124.1

(57) ABSTRACT

A gloss control particle is provided that is configured to form a transparent and colorless gloss control layer on a colored toner image which is to be fixed on a recording medium upon application of heat, wherein the gloss control particle contains a binder resin and a softening agent configured to soften the binder resin upon application of heat, along with a developer containing the gloss control particle and an image forming method using the developer containing the gloss control particle.

### BACKGROUND OF THE INVENTION

1. Field of the Invention

The present invention relates to a gloss control particle for use in electrophotography. In addition, the present invention also relates to a developer set and an image forming method using the gloss control particle.

2. Discussion of the Background

High-gloss images produced by electrophotography using yellow, magenta, cyan, and black toners typically have a difference in gloss between image portions and non-image (background) portions, which makes the images unnatural.

In attempting to solve such a problem, Unexamined Japanese Patent Application Publication No. (hereinafter “JP-A-”) 2005-099122 discloses a transparent toner which includes a polyester resin in an amount of 70% or more by weight based on the whole binder resins.

JP-A-2001-175022 also discloses a transparent toner, which is used for a color image forming method using yellow, magenta, cyan, and black toners. The storage elastic modulus (G′1) of the transparent toner is smaller than that (G′2) of one of the yellow, magenta, cyan, and black toners, which are measured by a dynamic viscoelasticity measuring instrument at 140° C. The transparent toner includes polyester and polyol resins having a specific molecular weight to have a desired storage elastic modulus.

Both of the above-described transparent toners are fixed on and around a colored toner image to provide a natural high-gloss image. However, such a formation of a transparent toner layer does not give sufficient gloss to a resultant image particularly in image forming methods using a one-component developer (hereinafter “one-component developing methods”). This is because one-component developers are typically required to have durability, which may degrade gloss-giving ability of the transparent toners.

More specifically, to give high gloss to a resultant toner image, binder resins in the toner are required to be deformed and flattened at a surface region of the toner image. To accelerate deformation and flattening of binder resins, the molecular weight thereof may be lowered. However, lowering of the molecular weight causes lowering of the glass transition temperature (Tg) or physical strength as well. Such a situation is not suitable for one-component developing methods because toners receive more heat and mechanical stress in one-component developing methods than in other developing methods.

### SUMMARY OF THE INVENTION

Accordingly, an object of the present invention is to provide a gloss control particle which provides high-gloss images and has high resistance to mechanical stress which may be applied in one-component developing methods.

Another object of the present invention is to provide a developer set and an image forming method which provide high-gloss images in one-component developing methods.

These and other objects of the present invention, either individually or in combinations thereof, as hereinafter will become more readily apparent can be attained by a gloss control particle, comprising:

a binder resin; and

a softening agent configured to soften the binder resin upon application of heat;

wherein the gloss control particle is configured to form a transparent and colorless gloss control layer on a colored toner image which is to be fixed on a recording medium upon application of heat;

and a developer set and an image forming method using the gloss control particle.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of an image forming apparatus for explaining the image forming method of the present invention; and

FIG. 2 is a graph for explaining how to determine the glass transition temperature.

### DETAILED DESCRIPTION OF THE INVENTION

The inventors of the present invention focused attention on a material capable of softening a binder resin upon application of heat, that is, at the time a toner image is fixed on a recording medium. Such a material is hereinafter referred to as a “softening agent”. When colorless and transparent particles including a binder resin and a softening agent capable of softening the binder resin upon application of heat are formed into a layer on a colored toner image, the particles may be softened at the time the toner image is fixed on a recording medium upon application of heat, while the softening agent expresses little or no affinity for the binder resin before the toner image is fixed on a recording medium. Therefore, such colorless and transparent particles maybe resistant to mechanical stress which may be applied in one-component developing methods while being easily softened and deformed upon application of heat.

Generally, the present invention provides a gloss control particle which forms a transparent and colorless gloss control layer on a colored toner image which is to be fixed on a recording medium upon application of heat. The gloss control particle comprises a binder resin and a softening agent that softens the binder resin upon application of heat. Within the context of the present invention, the term “particle” can refer to a single particle as well as a plurality of particles, which may be individual particles or aggregated particles, or a combination thereof.

The softening agent preferably melts at the time the colored toner image is fixed on a recording medium upon application of heat so that the binder resin is plasticized or softened. The toner image is typically fixed at a temperature of about 120 to 210° C. Therefore, the softening agent has a melting point that is lower than the fixing temperature, preferably a melting point of 40 to 140° C., more preferably 50 to 140° C., and much more preferably 60 to 120° C. However, when the melting point is too low, the surface of the fixed image may have poor heat-resistance.

If the gloss control particle does not include any softening agent, the binder resin may not be sufficiently softened. Therefore, the resultant layer of the gloss control particle may not be smooth, resulting in low-gloss image. Alternatively, if the gloss control particle merely includes a low-melting-point material or a liquid plasticizer, the binder resin may be softened due to pressure from a developing roller or a slight rise of temperature without fixing the toner image on a recording medium. As a consequence, particles of the gloss control particle may firmly stick to one another or aggregate.

The softening agent preferably includes at least one of a carboxylic acid group and an amide bond group in a molecule thereof. In this case, the softening agent can effectively plasticize or soften the binder resin while the melting point thereof is increased.

As described above, the softening agent preferably has a melting point of 40 to 140° C. and at least one of a carboxylic acid group and an amide bond group in a molecule thereof. Specific examples of suitable materials for the softening agent include, but are not limited to, aliphatic carboxylic acid compounds, aromatic carboxylic acid compounds, aliphatic amide compounds, and aromatic compounds, such as stearic acid (69° C.), hydroxystearic acid (75° C.), sebacic acid (132° C.), benzoic acid (122° C.), 2-biphenyl carboxylic acid (108° C.), m-hydroxyphenyl acetic acid (131° C.), stearic acid amide (109° C.), N-hydroxyethyl-12-hydroxystearyl amide (105° C.), N,N′-hexamethylenebis-12-hydroxystearyl amide (135° C.), N,N′-xylylenebis-12-hydroxystearyl amide (125° C.), N,N′-ethylenebis-oleyl amide (114° C.), and benzamide (130° C.) Values in brackets refer to melting points.

The gloss control particle preferably includes the softening agent in an amount of 0.5 to 30% by weight, and more preferably 2 to 20% by weight, based on the weight of the binder resin. When the amount is too small, the binder resin may not be sufficiently softened. When the amount is too large, physical strength of the gloss control particle may deteriorate, possibly melting upon application of thermal and mechanical stress.

Suitable binder resins for the gloss control particle are preferably the same as suitable binder resins for colored toners for forming colored toner images. Therefore, specific preferred examples of suitable binder resins for the gloss control particle will be described in detail below in descriptions of colored toners.

When the binder resin of the gloss control particle is different from the binder resin of the colored toner, the gloss control particle and the colored toner may not become completely compatible, resulting in formation of an interface therebetween. Since these binder resins have different refractive index, light tends to diffuse at the interface. As a result, color may not be reproduced accurately in a resultant image or the resultant image may be cloudy.

The gloss control particle preferably has a volume average particle diameter of 3 to 9 μm, more preferably 4 to 8 μm, and much more preferably 5 to 7 μm. When the volume average particle diameter is too small, it is hard to handle such small particles. When the volume average particle is too large, a greater amount of the gloss control particle is needed to form an even layer.

For the purpose of controlling charge and fluidity, the gloss control particle may include a charge controlling agent and a fluidity controlling agent as well as the colored toner. In addition, a wax may also be added so as to improve lubricity.

The gloss control particle can be produced by any granulation method. For example, granulation methods using interfacial polymerization, in-situ polymerization, phase separation, hardening and coating in liquids, coacervation, and the like, can be used. Preferably, the gloss control particle is produced by the same production method as colored toners except for replacing colorants with the softening agent.

The colored toner includes a binder resin and a colorant, and optionally a charge controlling agent, a release agent, a fluidity improving agent, an antioxidant, and the like. To form colored toner particles, first, these components are mixed at a specific ratio. The mixture is then melt-kneaded, and the melt-kneaded mixture is pulverized into particles. The particles are classified so as to collect particles of the desired size. It is to be noted that the release agent and the fluidity improving agent may be added both internally and externally.

The above-described method is a so-called “pulverization method”, which is one type of physical granulation method. Besides physical production methods, chemical granulation methods are preferable, such as a dry granulation method in which droplets of a solvent in which a binder resin is dissolved are dried; a solidification granulation method in which an aqueous medium is removed from an O/W emulsion; an emulsion aggregation method; a suspension polymerization method; and a partial polymerization method in which a binder resin precursor is elongated in a liquid. Of course, these physical and chemical granulation methods can be used in combination.

Specific examples of suitable binder resins for the colored toner include, but are not limited to, polyester resins, methacrylic and acrylic resins, styrene-acrylic copolymer resins, styrene-methacrylic copolymer resins, epoxy resins, and cyclic olefin resins such as TOPAS-COC from Ticona. From the viewpoint of resistance to mechanical stress applied in developing, styrene-acrylic and styrene-methacrylic copolymer resins and polyester resins are preferable. From the viewpoint of low-temperature fixability, heat resistance, and stress resistance, polyester resins are preferable. When the polyester resin has a glass transition temperature of 40 to 80° C., preferably 50 to 70° C., the softening point thereof is decreased, which is preferable for fixing. The above-described resins can be used alone or in combination.

The binder resin preferably has a weight average molecular weight of 4,000 or more, from the viewpoint of physical strength and storage stability.

Specific examples of suitable colorants for use in the colored toner include any known dyes and pigments such as carbon black, Nigrosine dyes, black iron oxide, NAPHTHOL YELLOWS, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, C. I. Pigment Blue 15:3, C. I. Pigment Red 184, C. I. Pigment Red 269, C. I. Pigment Yellow 155, C. I. Pigment Yellow 180, titanium oxide, zinc oxide, lithopone, etc. These materials can be used alone or in combination. The toner preferably includes a colorant in an amount of from 1 to 15% by weight, and more preferably from 3 to 10% by weight.

The colored toner preferably includes a wax as release agent. Specific examples of suitable waxes include, but are not limited to, polyolefin waxes (e.g., polyethylene wax, polypropylene wax), long-chain hydrocarbons (e.g., paraffin wax, SASOL wax), and waxes having a carbonyl group. Specific examples of the waxes having a carbonyl group include, but are not limited to, esters of polyalkanoic acids (e.g., carnauba wax, montan wax, trimethylolpropane tribehenate, pentaerythritol tetrabehenate, pentaerythritol diacetate dibehenate, glycerin tribehenate, 1,18-octadecanediol distearate); polyalkanol esters (e.g., tristearyl trimellitate, distearyl maleate); polyalkanoic acid amides (e.g., ethylenediamine dibehenyl amide); polyalkylamides (e.g., trimellitic acid tri stearylamide); and dialkyl ketones (e.g., distearyl ketone). Among these waxes having a carbonyl group, polyalkanoic acid esters are preferable.

Specifically, hydrocarbon waxes having low polarity are preferable, such as polyethylene wax, polypropylene wax, paraffin wax, SASOL wax, microcrystalline wax, and Fisher-Tropsch wax. The toner includes the wax in an amount of 3 to 15% by weight, preferably 4 to 12% by weight, and more preferably 5 to 10% by weight, based on 100% by weight of the binder resin. When the amount of wax is too small, the wax may not sufficiently function as release agent and cause hot offset. When the amount of wax is too large, the wax may come out from toner particles upon application of thermal and mechanical stress and may contaminate image forming members such as photoreceptor, resulting in low-grade image. In addition, the wax may spread outside image portions when an image is formed on an OHP sheet, resulting in a low-grade projected image.

The toner may optionally include a charge controlling agent. Specific examples of the charge controlling agents include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and salicylic acid derivatives, but are not limited thereto.

Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, and azo pigments and polymers having a functional group such as a sulfonate group, a carboxyl group, and a quaternary ammonium group.

The toner may include inorganic particles and/or polymer particles so as to improve fluidity, developability, and chargeability.

The inorganic particles preferably have a primary particle diameter of 5 nm to 2 μm, and more preferably 5 nm to 500 nm, and a BET specific area of 20 to 500 m²/g. The toner preferably includes the inorganic particles in an amount of 0.01 to 5% by weight, and more preferably 0.01 to 2.0% by weight. Specific examples of the inorganic particles include, but are not limited to, particles of silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

Specific examples of usable polymer particles include, but are not limited to, particles of a polystyrene which are manufactured by a method such as soap-free emulsion polymerization method, suspension polymerization method, or dispersion polymerization method; methacrylate or acrylate copolymers; polycondensation resins such as silicone, benzoguanamine, and nylon resins; and thermosetting resins.

The above-described fluidity improving agents may be surface-treated so that hydrophobicity is increased. The higher the hydrophobicity, the better the fluidity and chargeability even in highly humid conditions. Specific examples of usable surface treatment agents include, but are not limited to, silane-coupling agents, silylation agents, silane-coupling agents having a fluorinated alkyl group, organic titanate coupling agents, aluminum coupling agents, silicone oils, and modified silicone oils.

Description is now given of methods for manufacturing toners.

First, pulverization methods are described in detail. In a typical pulverization method, first, a binder resin and toner components are mixed at a desired ratio and the mixture is melt-kneaded. The melt-kneaded mixture is then pulverized into particles, and the pulverized particles are classified so that desired sized particles are collected. Thus, mother toner particles are prepared. The shape of mother toner particles can be optionally controlled. For example, the circularity can be improved by applying mechanical impact thereto using an instrument such as HYBRIDIZER (from Nara Machinery Co., Ltd.) and MECHANOFUSION® (from Hosokawa Micron Corporation).

Preferably, toner components are mixed using a typical powder mixer. More preferably, the powder mixer is equipped with a jacket so that the inner temperature can be controlled. The rotation number, rolling speed, mixing time, and temperature of the powder mixer may be variable. In the mixing, a relatively high stress may be applied first and subsequently a relatively low stress is applied, or vice versa. Specific examples of usable mixers include, but are not limited to, V-form mixers, locking mixers, Loedge Mixers, NAUTER MIXERS, and HENSCHEL MIXERS.

The mixture is melt-kneaded using a single-axis or double-axis continuous kneader or a batch kneader using roll mill. Specific examples of commercially available usable kneaders include, but are not limited to, TWIN SCREW EXTRUDER KTK from Kobe Steel, Ltd., TWIN SCREW COMPOUNDER TEM from Toshiba Machine Co., Ltd., MIRACLE K.C.K from Asada Iron Works Co., Ltd., TWIN SCREW EXTRUDER PCM from Ikegai Co., Ltd., KOKNEADER from Buss Corporation, etc. The melt-kneading process should be performed such that molecular chains of binder resin are not cut.

The melt-kneaded mixture is pulverized into particles. Preferably, the melt-kneaded mixture is pulverized into coarse particles first and subsequently the coarse particles are pulverized into fine particles. Suitable pulverization methods include, but are not limited to, a method in which particles collide with a collision board in a jet stream; a method in which particles collide with each other in a jet stream; and a method in which particles are pulverized in a narrow gap formed between a mechanically rotating rotor and a stator.

The fine particles thus pulverized are classified so that desired-sized particles are obtained. Suitable classification methods include, but are not limited to, cyclone separation, decantation, and centrifugal separation. Ultra-fine particles can be removed by these methods.

After being subjected to the classification mentioned above, the particles are further classified by a centrifugal force in airflow to collect predetermined-sized particles, i.e., mother toner particles.

To enhance fluidity, storage stability, developability, and transferability, fine particles of an inorganic material such as hydrophobized silica (hereinafter “external additive”) may be mixed with the mother toner particles. The mixing can be performed using a typical powder mixer. Preferably, the powder mixer is equipped with a jacket so that the inner temperature can be controlled. By changing the timing when the external additive is added or the addition speed of the external additive, the stress on the external additive, in other words, the adhesion state of the external additive with the mother toner particles can be changed. The rotation number, rolling speed, mixing time, and temperature of the powder mixer may be variable. In the mixing, a relatively high stress may be applied first and subsequently a relatively low stress is applied, or vice versa. Specific examples of usable mixers include, but are not limited to, V-form mixers, locking mixers, Loedge Mixers, NAUTER MIXERS, and HENSCHEL MIXERS. The mixed particles thus prepared may be passed through a sieve having an opening of 250 mesh or more to remove coarse particles and aggregated particles.

As well as the pulverization method described above, the following chemical methods are preferable: dry granulation methods in which droplets of a solvent in which a binder resin is dissolved are dried; solidification granulation methods in which an aqueous medium is removed from an O/W emulsion; emulsion aggregation methods; suspension polymerization methods; and partial polymerization methods in which a binder resin precursor is elongated in liquid. Among these methods, emulsion aggregation methods, suspension polymerization methods, and an ester elongation polymerization method which is one of the partial polymerization methods will be described in detail below. Because of providing toner with high storage stability and low-temperature fixability, the ester elongation polymerization method is preferable.

Description is now given of emulsion aggregation methods. A toner prepared by an emulsion aggregation method includes a binder resin, a wax, and a colorant. The binder resin includes a vinyl resin formed from a radical-polymerizable monomer and may include other resins such as a polyester resin. In the emulsion aggregation method, a colorant dispersion, a binder resin latex, and a wax dispersion are subjected to aggregation in an aqueous medium so that aggregated particles containing the colorant, binder resin, and wax are formed. The aggregated particles thus prepared are then washed and dried, resulting in preparation of mother toner particles. More specifically, a radical-polymerizable monomer, a wax, a colorant, and an optional polyester resin are emulsified and aggregated in an aqueous medium, and the resultant aggregated particles are heated so that they are fused with each other.

The vinyl resin formed from a radical-polymerizable monomer is not limited to any particular resins. Multiple vinyl resins may be used in combination. The vinyl resin preferably has a weight average molecular weight of 50,000 or less, and more preferably 30,000 or less. When the weight average molecular weight is too large, low-temperature fixability of the resultant toner may deteriorate. The vinyl resin preferably has a glass transition temperature of 40 to 80° C., and more preferably 50 to 70° C. When the glass transition temperature is too high, low-temperature fixability of the resultant toner may deteriorate. When the glass transition temperature is too low, heat-resistant storage stability of the resultant toner may deteriorate.

The vinyl resin is formed by a copolymerization of vinyl monomers. Specific examples of usable vinyl monomers include, but are not limited to, (1) vinyl hydrocarbons (e.g., aliphatic vinyl hydrocarbons, alicyclic vinyl hydrocarbons, aromatic vinyl hydrocarbons), (2) vinyl monomers having a carboxyl group (e.g., acrylic acid, methacrylic acid, maleic acid, maleic anhydride, monoalkyl maleate, fumaric acid, monoalkyl fumarate, crotonic acid, itaconic acid, monoalkyl itaconate, itaconic acid glycol monoether, citraconic acid, monoalkyl citraconate, cinnamic acid) and salts thereof, (3) vinyl monomers having a sulfonic acid group and vinyl monoesters of sulfuric acids and salts thereof, (4) vinyl monomers having a phosphoric acid group and salts thereof, (5) vinyl monomers having a hydroxyl group, (6) nitrogen-containing vinyl monomers, (7) vinyl monomers having an epoxy group, (8) vinyl esters, vinyl ethers, vinyl thioethers, vinyl ketones, and vinyl sulfones, (9) vinyl monomers such as isocyanatoethyl acrylate, isocyanatoethyl methacrylate, m-isopropenyl-α,α-dimethylbenzyl isocyanate, and monomers having an alkyloxysilyl group, and (10) fluorine-containing vinyl monomers.

The optional polyester resin, which is used if needed, is not limited to any particular resins. Multiple polyester resins may be used in combination. Specifically, crystalline polyester resins are preferable because of providing both storage stability and low-temperature fixability.

An exemplary description is now given of suspension polymerization methods. In a typical suspension polymerization method, oil droplets of a polymerizable monomer composition in which a colorant and a wax are dispersed in a polymerizable monomer are subjected to suspension polymerization in an aqueous medium so that particles are produced. The particles thus produced are washed and dried, resulting in preparation of mother toner particles.

Specific examples of usable polymerizable monomers include, but are not limited to, the above-described radical-polymerizable monomers suitable for the emulsion aggregation methods.

Preferably, each toner component is evenly dispersed in a toner particle. Therefore, toner components are preferably evenly dispersed in the polymerizable monomer composition.

To evenly disperse toner components in the polymerizable monomer composition, a sufficient shearing force may be applied thereto. Accordingly, the polymerizable monomer composition preferably has a certain viscosity. To increase viscosity of the polymerizable monomer composition, other resins may be dissolved therein or part of the polymerizable monomer may be previously subjected to polymerization.

Because a part of shearing energy applied to the polymerizable monomer composition is transformed into thermal energy, cooling is required as appropriate. When cooling is insufficient for the generated heat, the temperature of the polymerizable monomer composition may increase, resulting in decrease of viscosity. As a consequence, the polymerizable monomer composition cannot be given a sufficient shearing force and toner components cannot be evenly dispersed therein.

In contrast, when the shearing force is too large, toner components may be excessively dispersed in the polymerizable monomer composition, resulting in an unstable dispersion. As a consequence, the toner components may be aggregated and cause lowering of image density.

Specific examples of suitable dispersers for dispersing the polymerizable monomer composition include, but are not limited to, ultrasonic dispersers, pressure dispersers such as mechanical homogenizer, MANTON GAULIN HOMOGENIZER, CLEAR MIX, CLEAR SS5, and pressure homogenizer, and media dispersers such as attritor, sand grinder, GETZMANN MILL, and diamond fine mill.

The colorant maybe surface-treated. One possible method for the surface treatment includes dispersing a colorant in a solvent, adding a surface treatment agent in the dispersion, and heating the dispersion so as to react the colorant and the surface treatment agent, filtering the reacted dispersion, repeatedly washing the deposited surface-treated colorant with the solvent, and drying the surface-treated colorant.

A polar resin such as polyester may be also used for the suspension polymerization method. When a polar resin is added in the process of dispersing or polymerization of monomers, the polar resin may form a thin layer thereof on the surfaces of resultant toner particles or have a concentration gradient from the surface to the interior of each of the resultant toner particles, depending on the polar balance between the polymerizable monomer composition and the aqueous medium. If the polar resin has a certain interaction with a colorant or magnetic material (optionally usable for preparing a magnetic toner), the colorant or magnetic material can be dispersed in resultant toner particles appropriately.

The polar resin is preferably added in an amount of 1 to 25 parts by weight, and more preferably 2 to 15 parts by weight, based on 100 parts by weight of the binder resin. When the amount is too small, the polar resin may be unevenly dispersed in toner particles. When the amount is too large, the polar resin may form too thick a layer on the surfaces of toner particles.

Specific examples of suitable polar resins include, but are not limited to, polyester resins, epoxy resins, styrene-acrylic resins, styrene-methacrylic acid copolymers, and styrene-maleic acid copolymers. Specifically, polyester resins having a molecular weight distribution having a peak at 3,000 to 10,000 are preferable because such resins provide fluidity, negative chargeability, and transparency.

A cross-linking agent may be added when the binder resin is formed so as to increase mechanical strength and molecular weight of the resultant toner.

Specific examples of usable cross-linking agents include, but are not limited to, difunctional cross-linking agents such as divinylbenzene, bis(4-acryloxypolyethoxyphenyl)propane, ethylene glycol diacrylate and dimethacrylate, 1,3-butylenediol diacrylate and dimethacrylate, 1,6-hexanediol diacrylate and dimethacrylate, neopentyl glycol diacrylate and dimethacrylate, diethylene glycol diacrylate and dimethacrylate, triethylene glycol diacrylate and dimethacrylate, tetraethylene glycol diacrylate and dimethacrylate, diacrylates and dimethacrylates of polyethylene glycols #200, #400, and #600, dipropylene glycol diacrylate and dimethacrylate, polypropylene glycol diacrylate and dimethacrylate, and polyester-based diacrylate (MANDA from Nippon Kayaku Co., Ltd.) and dimethacrylate; and polyfunctional cross-linking agents such as pentaerythritol triacrylate, trimethylolethane triacrylate, trimethylolpropane triacrylate, tetramethylolmethane tetraacrylate, oligoester acrylate and methacrylate, 2,2-bis(4-methacryloxy-polyethoxyphenyl)propane, diallyl phthalate, triallyl cyanurate, triallyl isocyanurate, and triallyl trimellitate.

The cross-linking agent is preferably added in an amount of 0.05 to 10 parts by weight, and more preferably 0.1 to 5 parts by weight, based on 100 parts by weight of the polymerizable monomer.

Suitable polymerization initiators for use in the suspension polymerization method include, but are not limited to, azo and diazo polymerization initiators such as 2,2′-azobis-(2,4-dimethyl valeronitrile), 2,2′-azobis isobutyronitrile, 1,1′-azobis(cyclohexane-1-carbonitrile), 2,2′-azobis-4-methoxy-2,4-dimethyl valeronitrile, and azobis isobutyronitrile; and peroxide polymerization initiators such as benzoyl peroxide, methyl ethyl ketone peroxide, diisopropyl peroxycarbonate, cumene hydroperoxide, 2,4-dichlorobenzoyl peroxide, and lauroyl peroxide. The polymerization initiator is typically used in an amount of 5 to 20 parts by weight based on 100 parts by weight of the polymerizable monomer, but it depends on the desired degree of polymerization. A suitable polymerization initiator may be selected depending on 10-hour half-life temperature. Of course, multiple polymerization initiators can be used in combination.

The aqueous medium for use in the suspension polymerization method is prepared using a dispersing agent. Specific examples of usable dispersing agents include, but are not limited to, inorganic dispersing agents such as tricalcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina; and organic dispersing agents such as polyvinyl alcohol, gelatine, methylcellulose, methylhydroxylpropyl cellulose, ethylcellulose, sodium salt of carboxymethyl cellulose, and starch.

In addition, commercially available nonionic, anionic, and cationic surfactants can be used, such as sodium dodecyl sulfate, sodium tetradecyl sulfate, sodium pentadecyl sulfate, sodium octyl sulfate, sodium oleate, sodium laurate, potassium stearate, and calcium oleate.

Among these dispersing agents, inorganic dispersing agents with poor water solubility are preferable for preparing the aqueous medium for use in the suspension polymerization method. Further, such inorganic dispersing agents with poor water solubility are preferably soluble in acids. Such an inorganic dispersing agent is preferably used in an amount of 0.2 to 2.0 parts by weight based on 100 parts by weight of the polymerizable monomer. The aqueous medium preferably includes water in an amount of 300 to 3,000 parts by weight based on 100 parts by weight of the polymerizable monomer composition.

To prepare an aqueous medium in which an inorganic dispersing agent with poor water solubility is dispersed, a commercially available inorganic agent may be directly dispersed in water. Alternatively, an inorganic dispersing agent with poor water solubility may be produced in a process in which water is agitated at a high speed. For example, mixing a sodium phosphate aqueous solution and a calcium chloride aqueous solution at a high speed may form fine particles of tricalcium phosphate.

An exemplary description is now given of ester elongation polymerization methods. A typical ester elongation polymerization method includes dispersing an oily liquid containing a colorant, a modified polyester (X) having an isocyanate group, and an unmodified polyester (Y) in an aqueous medium containing a surfactant so that toner particles including a modified polyester (Z) having urethane group and the unmodified polyester (Y) are produced. Preferably, the unmodified polyester (Y) has no isocyanate group and a specific acid value (15 mgKOH/g or more, for example). As an elongation and/or cross-linking agent for the modified polyester (X) having an isocyanate group, low-molecular-weight polyamines and polyols are preferable. Generally speaking, polymerization toners have advantages in fixability and image quality. Among various polymerization toners, toners prepared by ester elongation polymerization methods have excellent fixability because of including polyester resins and cross-linking structure. The cross-linking structure may be formed flexible so that the resultant toner may easily soften, in other words, fixability of the toner improves, without deteriorating physical strength of the toner.

The unmodified polyester (Y) has a certain polarity. Further, the unmodified polyester (Y) has a relatively low molecular weight and few cross-linking structures. The unmodified polyester (Y) preferably has a high acid value so as to have affinity for paper. Such a polyester may permeate and anchor into paper when a resultant toner image is fixed on the paper.

One example of the ester elongation polymerization methods will be described. First, an isocyanate-modified polyester (X) that has isocyanate groups on ends of molecular chains, an unmodified polyester (Y) that has no isocyanate group, a polyamine compound, and toner components such as a colorant, a release agent, a charge controlling agent, and a viscosity controlling agent are dissolved or dispersed in an organic solvent to prepare an oily liquid. Next, an aqueous medium containing a low-molecular-weight surfactant and/or a high-molecular-weight dispersant (e.g., particulate resin) is prepared. The oily liquid and the aqueous medium thus prepared are mixed and agitated so that the oily liquid is dispersed, in other words, emulsified in the aqueous medium. At the time of the emulsification, the oily liquid is formed into liquid droplets while the isocyanate groups of the isocyanate-modified polyester (X) and the amine groups of the polyamine compound are reacted. Thus, the isocyanate-modified polyester (X) is elongated forming urea bonds, resulting in formation of toner particles. Since the unmodified polyester (Y) has a function of permeating into paper, the molecular weight thereof is preferably low.

It is considered that the polyamine compound has functions of not only elongating the isocyanate-modified polyester (X) but also assisting dispersing of the isocyanate-modified polyester (X) in the aqueous medium. This is thought to be the case, because when the emulsification is performed without the polyamine compound, particles are formed that are too large or no particle is formed, which indicates that the emulsification is unstable. In particular, when the unmodified polyester (Y) has too high an acid value, the emulsification is more unstably performed and particles cannot be formed even if the amount of the low-molecular-weight surfactant and/or high-molecular-weight dispersant is increased. Taking the concept even further, a part of the polyamine compound is considered to escape from the oily liquid into the aqueous medium and controls pH of the aqueous medium. Therefore, in a case in which an inorganic base such as sodium hydroxide or potassium hydroxide control the pH instead of the polyamine compound, the stable dispersion can be performed even without the polyamine compound.

Heat-resistant storage stability of a toner formed by the above-described method depends on the glass transition temperature of the unmodified polyester resin (Y). Accordingly, the unmodified polyester resin (Y) preferably has a glass transition temperature of 40 to 80° C. When the glass transition temperature is too low, heat-resistant storage stability may be poor. When the glass transition temperature is too high, low-temperature fixability may be poor.

The unmodified polyester (Y) is not limited to any particular polyester, but polycondensation products of a polyol (1) and a polycarboxylic acid (2) are preferable.

Specific examples of usable polyols (1) include, but are not limited to, alkylene glycols such as ethylene glycol, 1,2-propylene glycol, 1,3-propylene glycol, 1,4-butanediol, and 1,6-hexanediol; alkylene ether glycols such as diethylene glycol, triethylene glycol, dipropylene glycol, polyethylene glycol, polypropylene glycol, and polytetramethylene ether glycol; alicyclic diols such as 1,4-cyclohexane dimethanol and hydrogenated bisphenol A; bisphenols such as bisphenol A, bisphenol F, and bisphenol S; 4,4′-dihydroxy biphenyls such as 3,3′-difluoro-4,4′-dihydroxy biphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (sometimes called tetrafluorobisphenol A), and 2,2-bis(3-hydroxyphenyl)-1,1,1,3,3,3-hexafluoropropane; bis(4-hydroxyphenyl)ethers such as bis(3-fluoro-4-hydroxyphenyl)ether; alkylene oxide (e.g., ethylene oxide, propylene oxide, butylene oxide) adducts of the above-described alicyclic diols; and alkylene oxide (e.g., ethylene oxide, propylene oxide, butylene oxide) adducts of the above-described bisphenols.

Among these compounds, alkylene glycols having 2 to 12 carbon atoms and alkylene oxide adducts of bisphenols are preferable, and combination of alkylene glycols having 2 to 12 carbon atoms and alkylene oxide adducts of bisphenols are more preferable.

In addition, polyvalent aliphatic alcohols having 3 or more valences such as glycerin, trimethylolethane, trimethylolpropane, pentaerythritol, and sorbitol; phenols having 3 or more valences such as trisphenol PA, phenol novolac, and cresol novolac; and alkylene oxide adducts of polyphenols having 3 or more valences are also usable as the polyol (1).

These polyols can be used alone or in combination.

Specific examples of usable polycarboxylic acids (2) include, but are not limited to, alkylene dicarboxylic acids such as succinic acid, adipic acid, and sebacic acid; alkenylene dicarboxylic acids such as maleic acids and fumaric acid; and aromatic dicarboxylic acids such as phthalic acid, isophthalic acid, terephthalic acid, naphthalene dicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl)hexafluoropropane, 2,2-bis(4-carboxyphenyl)hexafluoropropane, 2,2-bis(3-carboxyphenyl)hexafluoropropane, 2,2′-bis(trifluoromethyl)-4,4′-biphenyl dicarboxylic acid, 3,3′-bis(trifluoromethyl)-4,4′-biphenyl dicarboxylic acid, 2,2′-bis(trifluoromethyl)-3,3′-biphenyl dicarboxylic acid, and hexafluoroisopropylidene diphthalic acid anhydride.

Among these compounds, alkenylene dicarboxylic acids having 4 to 20 carbon atoms and aromatic dicarboxylic acids having 8 to 20 carbon atoms are preferable.

In addition, polycarboxylic acid having 3 or more valences including aromatic polycarboxylic acids having 9 to 20 carbon atoms such as trimellitic acid and pyromellitic acid, and anhydrides and lower alkyl esters (e.g., methyl ester, ethyl ester, isopropyl ester) of the above-described compounds are also usable as the polycarboxylic acid (2).

These polycarboxylic acids can be used alone or in combination.

The equivalent ratio [OH]/[COOH] of hydroxyl groups [OH] in the polyol (1) and carboxyl groups [COOH] in the polycarboxylic acid (2) is typically 2/1 to 1/1, preferably 1.5/1 to 1/1, and more preferably 1.3/1 to 1.02/1.

The unmodified polyester (Y) typically has a molecular weight distribution having a peak within a molecular weight range of 1,000 to 30,000, preferably 1,500 to 10,000, and more preferably 2,000 to 8,000. When the peak is at too small a molecular weight, heat-resistant storage stability may be poor. When the peak is at too large a molecular weight, low-temperature fixability may be poor.

The isocyanate-modified polyester (X) may be a reaction product of a polyisocyanate and a polyester (A) which is a polycondensation product of a polyol (Ao) and a polycarboxylic acid (Ac) and which has an active hydrogen group. The polyol (Ao) and the polycarboxylic acid (Ac) are equivalent to the polyol (1) and the polycarboxylic acid (2) described above, respectively. Specific examples of the active hydrogen groups include, but are not limited to, alcoholic hydroxyl groups, phenolic hydroxyl groups, amino groups, carboxylic groups, and mercapto groups. Among these groups, alcoholic hydroxyl groups are preferable.

Specific examples of usable polyisocyanates include, but are not limited to, aliphatic polyisocyanates such as tetramethylene diisocyanate, hexamethylene diisocyanate, and 2,6-diisocyanatomethyl caproate; alicyclic polyisocyanates such as isophorone diisocyanate and cyclohexylmethane diisocyanate; aromatic diisocyanates such as tolylene diisocyanate and diphenylmethane diisocyanate; aromatic aliphatic diisocyanates such as α, α, α′, α′-tetramethylxylylene diisocyanate; isocyanurates; the above-described polyisocyanates blocked with a phenol derivative, oxime, or caprolactam; and mixtures thereof.

The equivalent ratio [NCO]/[OH] of isocyanate groups [NCO] in the polyisocyanate hydroxyl groups [OH] in the polyester (A) is typically 5/1 to 1/1, preferably 4/1 to 1.2/1, and more preferably 2.5/1 to 1.5/1. When [NCO]/[OH] is too large, low-temperature fixability may be poor. When [NCO]/[OH] is too small, cross-linking density of the elongated and/or cross-linked isocyanate-modified polyester (X) may be low, possibly degrading offset resistance.

The isocyanate-modified polyester (X) typically includes the polyisocyanate units in an amount of 0.5 to 40% by weight, preferably 1 to 30% by weight, and more preferably 2 to 20% by weight. When the amount is too small, hot offset resistance may be poor. When the amount is too large, low-temperature fixability may be poor.

The number of isocyanate groups included in the isocyanate-modified polyester (X) is typically 1 or more, preferably 1.5 to 3, and more preferably 1.8 to 2.5 per molecule. When the number is too small, the molecular weight of the elongated and/or cross-linked isocyanate-modified polyester (X) may be low, possibly degrading offset resistance.

Specific examples of usable elongation and/or cross-linking agents include, but are not limited to, low-molecular-weight polyamines and polyols. Polyamines are more preferable.

Specific examples of usable polyols include the above-described polyols usable for the polyesters.

Specific examples of usable low-molecular weight polyamines include, but are not limited to, aromatic diamines such as phenylenediamine, diethyltoluene diamine, 4,4′-diaminodiphenylmethane, tetrafluoro-p-xylylene diamine, and tetrafluoro-p-phenylenediamine; alicyclic diamines such as 4,4′-diamino-3,3′-dimethyldicyclohexylmethane, diaminocyclohexane, and isophorone diamine; aliphatic diamines such as ethylene diamine, tetramethylene diamine, hexamethylene diamine, dodecafluorohexylene diamine, and tetracosafluorododecylene diamine; and polyamines having 3 or more valences such as diethylene triamine and triethylene tetramine.

The colorant can be combined with a resin to be used as a master batch. Specific examples of usable resin for the master batch include, but are not limited to, the above-described modified and unmodified polyester resins, styrene polymers and substituted styrene polymers (e.g., polystyrene, poly-p-chlorostyrene, polyvinyltoluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloro methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleic acid ester copolymer), polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. These resins can be used alone or in combination.

The master batches can be prepared by mixing one or more of the resins as described above and the colorant as described above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

Specific examples of usable release agents include the above-described release agents usable for the pulverization methods.

The above-described usable external additives such as fine particles of inorganic materials and/or polymers may be also used to improve fluidity, developability, and chargeability of the resultant toner.

A cleanability improving agent may be added to the toner so that toner particles which remain on the surface of photoreceptor or primary transfer medium without being transferred are easily removed. Specific examples of usable cleanability improving agents include, but are not limited to, metal salts of fatty acids such as such as zinc stearate and calcium stearate; and particulate polymers such as polymethyl methacrylate and polystyrene, which are manufactured by a method such as soap-free emulsion polymerization methods. Particulate resins having a relatively narrow particle diameter distribution and a volume average particle diameter of from 0.01 μm to 1 μm are preferably used as the cleanability improving agent.

Volatile organic solvents having a boiling point of less than 100° C. are suitable for dissolving or dispersing the unmodified polyester resin, the modified polyester resin having an isocyanate group, a colorant, and a release agent because such solvents are easily removed in succeeding processes. Specific examples of such organic solvents include, but are not limited to, toluene, xylene, benzene, carbon tetrachloride, methylenechloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination. Among these solvents, ester solvents such as methyl acetate and ethyl acetate, aromatic solvents such as toluene and xylene, and halogenated hydrocarbons such as methylene chloride, 1,2-dichloroethane, chloroform, and carbon tetrachloride are preferable. The polyester resins, colorant, and release agent may be dissolved or dispersed in the solvent simultaneously. Alternatively, each of them may be separately dissolved or dispersed in a separate solvent. In this case, the separate solvents may be, but need not necessarily be, the same. However, in consideration of solvent removal in succeeding processes, the separate solvents are preferably the same.

The resultant solution or dispersion preferably contains the polyester resins in an amount of 40 to 80% by weight. When the amount of the polyester resins is too large, the solution or dispersion may be hard to be emulsified and handled because the viscosity thereof is too high. When the amount of the polyester resins is too small, productivity of toner may reduce.

The unmodified resin and the modified polyester resin having an isocyanate group may be dissolved or dispersed in the same solvent simultaneously. Alternatively, each of them may be dissolved or dispersed in a separate solvent. However, in consideration of the difference in solubility and viscosity, each of them is preferably dissolved or dispersed in a separate solvent.

The colorant may be dissolved or dispersed in the solvent alone. Alternatively, the colorant may be mixed with the solution or dispersion in which the polyester resins are dissolved or dispersed. A dispersing auxiliary agents and another polyester resin may be added if needed. The colorant master batch described above can be also usable.

When the release agent is to be dispersed in a solvent in which the release agent is insoluble, the release agent is preferably mixed with the solvent using a dispersing machine such as bead mill. More preferably, after mixing the release agent with the solvent, the mixture is once heated to the melting point of the release agent and subsequently cooled while being agitated, followed by dispersing using the bead mill described above. This procedure may make the dispersing time shorter. Of course, multiple release agents can be used in combination, and a dispersing auxiliary agent and another polyester resins may be added, if needed.

As the aqueous medium, water alone or a mixture of water and a water-miscible solvent are preferable. Specific examples of usable water-miscible solvents include, but are not limited to, alcohols such as methanol, isopropanol, and ethylene glycol; dimethylformamide; tetrahydrofuran; cellosolves such as methyl cellosolve; and lower ketones such as acetone and methyl ethyl ketone. The usable amount of the aqueous medium is typically 50 to 2,000 parts by weight, and preferably 100 to 1,000 parts by weight, based on 100 parts by weight of toner components. When the amount of the aqueous medium is too small, toner components may be insufficiently dispersed therein, resulting in undesired-size toner particles. When the amount of the aqueous medium is too large, manufacturing cost may increase.

Inorganic bases are usable for controlling the pH of the aqueous medium. The purpose for using inorganic bases is to limit usage of low-molecular-weight amines and hydroxyl compounds as elongation agents and to produce amines as hydrolysis products. Specific examples of usable inorganic bases include, but are not limited to, hydroxides such as lithium hydroxide, sodium hydroxide, potassium hydroxide, cesium hydroxide, magnesium hydroxide, and calcium hydroxide; carbonates such as lithium carbonate, sodium carbonate, potassium carbonate, cesium carbonate, magnesium carbonate, and calcium carbonate; hydrogen carbonates such as lithium hydrogen carbonate, sodium hydrogen carbonate, potassium hydrogen carbonate, cesium hydrogen carbonate, magnesium hydrogen carbonate, and calcium hydrogen carbonate; and mixtures thereof. The aqueous medium is controlled to have a pH of 9 or more. More specifically, the pH is controlled depending on resins, colorants, and release agents which are to be dissolved or dispersed in an organic solvent.

Water-soluble amine compounds are also usable for controlling the pH. However, these compounds may slightly degrade chargeability of the resultant toner.

Preferably, an inorganic dispersing agent or an organic particulate resin is dispersed in the aqueous medium so that a resultant dispersion is stable and resultant toner particles have a narrow particle diameter distribution. Specific examples of usable inorganic dispersing agents include, but are not limited to, tricalcium phosphate, calcium carbonate, titanium oxide, colloidal silica, and hydroxyapatite. As the organic particulate resin, any thermoplastic and thermosetting resins capable of forming an aqueous dispersion thereof are usable. Specific examples of such resins include, but are not limited to, vinyl resins, polyurethane resins, epoxy resins, polyester resins, polyamide resins, polyimide resins, silicon resins, phenol resins, melamine resins, urea resins, aniline resins, ionomer resins, and polycarbonate resins. These resins can be used alone or in combination. Among these resins, vinyl resins, polyurethane resins, epoxy resins, polyester resins, and mixtures thereof are preferable because they can easily form an aqueous dispersion containing fine spherical particles thereof.

Specific preferred methods for forming an aqueous dispersion of a particulate resin include the following methods (a) to (h), for example.
(a) Subjecting a vinyl monomer to any one of suspension polymerization, emulsion polymerization, seed polymerization, and dispersion polymerization, so that an aqueous dispersion of a particulate resin is directly prepared.
(b) Dispersing a precursor (such as a monomer and an oligomer) of a polyaddition or polycondensation resin (such as a polyester resin, a polyurethane resin, and an epoxy resin) or a solvent solution thereof in an aqueous medium in the presence of a suitable dispersing agent, followed by heating or adding a curing agent, so that an aqueous dispersion of a particulate resin is prepared.
(c) Dissolving a suitable emulsifying agent in a precursor (such as a monomer and an oligomer) of a polyaddition or polycondensation resin (such as a polyester resin, a polyurethane resin, and an epoxy resin) or a solvent solution (preferably in liquid form, if not liquid, preferably liquefied by application of heat) thereof, and subsequently adding water thereto, so that an aqueous dispersion of a particulate resin is prepared by phase-inversion emulsification.
(d) Pulverizing a resin previously formed by a polymerization reaction (such as addition polymerization, ring-opening polymerization, polyaddition, addition condensation, condensation polymerization) using a mechanical rotational type pulverizer or a jet type pulverizer, classifying the pulverized particles to prepare a particulate resin, and dispersing the particulate resin in an aqueous medium in the presence of a suitable dispersing agent, so that an aqueous dispersion of the particulate resin is prepared.
(e) Spraying a resin solution, in which a resin previously formed by a polymerization reaction (such as addition polymerization, ring-opening polymerization, polyaddition, addition condensation, condensation polymerization) is dissolved in a solvent, into the air to prepare a particulate resin, and dispersing the particulate resin in an aqueous medium in the presence of a suitable dispersing agent, so that an aqueous dispersion of the particulate resin is prepared.
(f) Adding a poor solvent to a resin solution, in which a resin previously formed by a polymerization reaction (such as addition polymerization, ring-opening polymerization, polyaddition, addition condensation, condensation polymerization) is dissolved in a solvent, or cooling the resin solution which is previously dissolved in a solvent with application of heat, to precipitate a particulate resin, and dispersing the particulate resin in an aqueous medium in the presence of a suitable dispersing agent, so that an aqueous dispersion of the particulate resin is prepared.
(g) Dispersing a resin solution, in which a resin previously formed by a polymerization reaction (such as addition polymerization, ring-opening polymerization, polyaddition, addition condensation, condensation polymerization) is dissolved in a solvent, in an aqueous medium in the presence of a suitable dispersing agent, and removing the solvent by application of heat, reduction of pressure, and the like, so that an aqueous dispersion of a particulate resin is prepared.
(h) Dissolving a suitable emulsifying agent in a resin solution, in which a resin previously formed by a polymerization reaction (such as addition polymerization, ring-opening polymerization, polyaddition, addition condensation, condensation polymerization) is dissolved in a solvent, and subsequently adding water thereto, so that an aqueous dispersion of a particulate resin is prepared by phase-inversion emulsification.

When the oily liquid containing toner components is emulsified in the aqueous medium, a surfactant is usable, if needed. Specific examples of usable surfactants include, but are not limited to, anionic surfactants such as alkylbenzene sulfonates, α-olefin sulfonates, and phosphates; cationic surfactants such as amine salts (e.g., alkylamine salts, amino alcohol fatty acid derivatives, polyamine fatty acid derivatives, imidazoline) and quaternary ammonium salts (e.g., alkyl trimethyl ammonium salts, dialkyl dimethyl ammonium salts, alkyl dimethyl benzyl ammonium salts, pyridinium salts, alkyl isoquinolinium salts, benzethonium chloride); nonionic surfactants such as fatty acid amide derivatives and polyvalent alcohol derivatives; and ampholytic surfactants such as alanine, dodecyl di(aminoethyl)glycine, di(octyl aminoethyl)glycine, and alkyl-N,N-dimethyl ammonium betaine.

Surfactants having a fluoroalkyl group are effective even in small amounts. Specific preferred examples of usable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20)carboxylic acids and metal salts thereof, perfluoroalkyl(C7-C13)carboxylic acids and metal salts thereof, perfluoroalkyl(C4-C12)sulfonic acids and metal salts thereof, perfluorooctane sulfonic acid dimethanol amide, N-propyl-N-(2-hydroxyethyl)perfluorooctane sulfonamide, perfluoroalkyl(C6-C10)sulfonamide propyl trimethyl ammonium salts, perfluoroalkyl(C6-C10)-N-ethyl sulfonyl glycine salts, and monoperfluoroalkyl(C6-C16) ethyl phosphates.

Specific preferred examples of usable cationic surfactants having a fluoroalkyl group include, but are not limited to, aliphatic primary, secondary, and tertiary amine acids having a fluoroalkyl group, aliphatic tertiary ammonium salts such as perfluoroalkyl(C6-C10)sulfonamide propyl trimethyl ammonium salts, benzalkonium salts, benzethonium chloride, pyridinium salts, and imidazolinium salts.

Polymeric protective colloids are also usable for preparing a stable dispersion. Specific examples of usable polymeric protection colloids include, but are not limited to, homopolymers and copolymers of monomers such as acid monomers (e.g., acrylic acid, methacrylic acid, α-cyanoacrylic acid, α-cyanomethacrylic acid, itaconic acid, crotonic acid, fumaric acid, maleic acid, maleic anhydride), (meth)acrylic monomers having hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, N-methylol methacrylamide), vinyl alcohols and ethers of vinyl alcohols (e.g., vinyl methyl ether, vinyl ethyl ether, vinyl propyl ether), esters of vinyl alcohols with compounds having carboxyl group (e.g., vinyl acetate, vinyl propionate, vinyl butyrate), monomers having amide bond and methylol compounds thereof (e.g., acrylamide, methacrylamide, diacetone acrylamide), acid chloride monomers (e.g., acrylic acid chloride, methacrylic acid chloride), monomers containing nitrogen or a heterocyclic ring containing nitrogen (e.g., vinyl pyridine, vinyl pyrrolidone, vinyl imidazole, ethylene imine); polyoxyethylenes such as polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters, and polyoxyethylene nonylphenyl esters; and celluloses such as methyl cellulose, hydroxyethyl cellulose, and hydroxypropyl cellulose.

Acid-soluble or alkaline-soluble dispersing agents such as calcium phosphate can be removed from the resultant particles by dissolving them by an acid, followed by washing with water. Alternatively, dispersing agents may be removed using enzymes. Of course, the dispersing agents may remain on the resultant particles, however, it is preferable to remove them from the viewpoint of chargeability.

To disperse (emulsify) the oily liquid in the aqueous medium, any known dispersing machines such as low-speed shearing machines, high-speed shearing machines, friction type dispersing machines, high pressure jet type dispersing machines, and ultrasonic dispersing machine can be used. In order to prepare a dispersion containing particles having particle diameters of 2 to 20 μm, high-speed shearing machines are preferable. When high-speed shearing machines are used, the rotation speed of rotors is generally from 1,000 to 30,000 rpm and preferably from 5,000 to 20,000 rpm, but is not limited thereto. The temperature at the dispersing is generally 0 to 150° C. (under pressure), and preferably from 20 to 80° C.

In order to remove the organic solvent from the thus prepared emulsion, any known removing methods can be used. For example, a method in which the emulsion is gradually heated under normal pressure or reduced pressure to completely evaporate the organic solvent in the drops of the oil phase can be used.

The isocyanate-modified polyester generally starts elongating and/or cross-linking at the time the oily liquid containing the isocyanate-modified polyester, unmodified polyester, colorant, and release agent is added to the aqueous medium. Alternatively, a reaction process for elongating and/or cross-linking the isocyanate-modified polyester may be separately performed. Conditions for the reaction process are determined depending on the activity and concentration of the isocyanate group. The reaction time is typically 1 minute to 40 hours and preferably 1 to 24 hours. The reaction temperature is typically 0 to 150° C. and preferably 20 to 98° C.

Resultant toner particles dispersed in the aqueous medium are washed and dried by a known method. For example, the toner particles and the aqueous medium are separated using a centrifugal separator or a filter press (i.e., solid-liquid separation) so that a toner cake is prepared, and then the toner cake is re-dispersed in ion-exchanged water at a temperature of room temperature to about 40° C., following by pH control using acids and bases, if desired. The solid-liquid separation is repeated several times to remove impurities and surfactants. After the washing treatment, the toner particles are subjected to a drying treatment using a flash dryer, a circulating dryer, a vacuum dryer, a vibrating fluid dryer, etc. Ultra-fine particles can be removed by centrifugal separation in the liquid, or the toner particles can be subjected to a classification treatment using a known classifier after the drying treatment.

The thus prepared toner particles are then mixed with one or more other particulate materials such as charge controlling agents, fluidizers optionally upon application of mechanical impact thereto to fix the particulate materials on the toner particles. Specific examples of such mechanical impact application methods include methods in which a mixture is mixed with a highly rotated blade and methods in which a mixture is put into an air jet to collide the particles against each other or a collision plate. Specific examples of such mechanical impact applicators include, but are not limited to, ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTON SYSTEM (manufactured by Kawasaki Heavy Industries, Ltd.), and automatic mortars.

Both the colored toner containing a binder resin and a colorant and the gloss control particle which are subjected to an appropriate external treatment and mixed with a carrier can be used for two-component developers as well as one-component developers.

Since the colored toner and the gloss control particle preferably contains the same binder resin, these are preferably used in combination as a developer set.

Description is now given of an embodiment of the image forming method of the present invention.

The image forming method of the present invention comprises an electrostatic latent image forming process in which an electrostatic latent image is formed on an electrostatic latent image bearing member, a developing process in which the electrostatic latent image is developed with a plurality of developers to form a toner image, a transfer process in which the toner image is transferred onto a recording medium, and a fixing process in which the toner image is fixed on the recoding medium upon application of heat. The plurality of developers is contained in the developer set described above so that a gloss control layer is formed on the recording medium as an outermost layer. The gloss control layer is preferably formed covering all over the recording medium, not only the toner image.

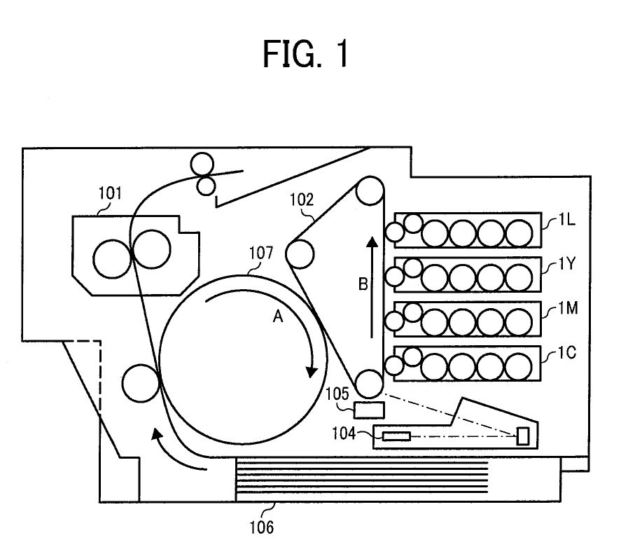

FIG. 1 is a schematic view illustrating an embodiment of an image forming apparatus for explaining the image forming method of the present invention. The image forming apparatus includes a photoreceptive belt 102 serving as an electrostatic latent image bearing member. Developing devices 1L, 1Y, 1M, and 1C containing the gloss control particle, yellow toner, magenta toner, and cyan toner, respectively, are disposed on the right side of the photoreceptive belt 102 in FIG. 1. An irradiator 104 configured to form an electrostatic latent image on the photoreceptive belt 102 is disposed below the developing device 1C. A charger 105 is disposed below the photoreceptive belt 102. A paper feed cassette 106 configured to store a recoding medium such as paper is disposed below the irradiator 104.

A transfer drum 107 serving as an intermediate transfer member is disposed on the left side of the photoreceptive belt 102 in FIG. 1. A fixing device 101 is disposed above the transfer drum 107. Each of the developing devices 1L, 1Y, 1M, and 1C has a discernible portion, such as projection, so as to be set to a predetermined part of the image forming apparatus.

The photoreceptive belt 102 is driven to rotate in a direction indicated by arrow B in FIG. 1. A photoconductive layer on the surface of the photoreceptive belt 102 is evenly charged by the charger 105. The irradiator 104 emits light containing image and/or text information sent from a personal computer or an image scanner to the photoreceptive belt 102 so that an electrostatic latent image is formed with dots thereon. The electrostatic latent image formed on the photoreceptive belt 102 is then developed with one of the yellow, magenta, and cyan toners contained in the developing devices 1Y, 1M, and 1C, respectively, to form a correspondent-color toner image, and a gloss control layer is formed thereon. The toner image having the gloss control layer thereon is then transferred onto the transfer drum 107 that is rotating in a direction indicated by arrow A.

The above-described operation is repeated so that each of the developing devices 1Y, 1M, and 1C sequentially forms a toner image on the transfer drum 107, resulting in a composite toner image. On the transfer drum 107, the colored toner images are formed on the gloss control layer. In other words, the gloss control layer is in contact with the transfer drum 107.

In the above-described method, gloss control layers and toner images are superimposed on one another on a photoreceptor. Alternatively, gloss control layers and toner images are superimposed on one another on a transfer medium so that at least an outermost layer of a resultant image may be a gloss control layer on a recording medium. For example, first, an electrostatic latent image formed on the photoreceptive belt 102 is developed by the developing device 1L so that a gloss control layer is formed on the photoreceptive belt 102. Subsequently, the gloss control layer is transferred onto the transfer drum 107 that is rotating in a direction indicated by arrow A. Similarly, subsequent electrostatic latent images formed on the photoreceptive belt 102 are sequentially developed with the yellow, magenta, and cyan toners contained in the developing devices 1Y, 1M, and 1C, respectively, to form color toner images, and the color toner images thus formed are sequentially transferred onto the gloss control layer on the transfer drum 107, resulting in a composite toner image having a gloss control layer as an outermost layer.

On the other hand, a sheet of a recording medium such as paper and OHP is fed from the paper feed cassette 106 so that the composite toner image is transferred thereon. On the recording medium, the gloss control layer is formed on the colored toner images. In other words, the gloss control layer serves as an outermost layer.

The recording medium having the composite toner image, which has a gloss control layer as an outermost layer, thereon is then conveyed to the fixing device 101 so that the composite toner image is fixed on the recording medium by application of heat and pressure. The fixed composite toner image is discharged to an upper side of the image forming apparatus. At the time of fixing, the softening agent softens the binder resin of the gloss control particle, resulting in a high-gloss image.

In the image forming apparatus illustrated in FIG. 1, the gloss control particle is contained in the developing device which is normally used for black toner. Alternatively, another preferable embodiment includes five developing devices each containing yellow toner, magenta toner, cyan toner, black toner, and gloss control particles.

The developer set of the present invention is also preferable for one-component developing methods in which a developer layer having a predetermined thickness is formed on a developer bearing member by a developer layer control member so that the developer layer develops an electrostatic latent image formed on an electrostatic latent image bearing member.

The particle diameters of toner can be measured using an instrument such as COULTER COUNTER TA-II and COULTER MULTISIZER II (from Beckman Coulter K. K.), for example.

A typical measuring method is as follows:
(1) 0.1 to 5 ml of a surfactant (preferably an alkylbenzene sulfonate) is included as a dispersant in 100 to 150 ml of an electrolyte (i.e., 1% NaCl aqueous solution including a first grade sodium chloride such as ISOTON-II from Coulter Electrons Inc.);
(2) 2 to 20 mg of a toner is added to the electrolyte and dispersed using an ultrasonic dispersing machine for about 1 to 3 minutes to prepare a toner suspension liquid;
(3) the volume and number of toner particles in the toner suspension liquid are measured by the above instrument using an aperture of 100 μm; and
(4) the volume average particle diameter (Dv) and the number average particle diameter (Dp) are determined from the volume and number distributions, respectively.

The channels include the following 13 channels: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.

The shape of a toner particle is preferably determined by an optical detection method such that a suspension containing toner particles is passed through an image detector located on a flat plate so that the image of each of the particles is optically detected by a CCD camera and analyzed.

The circularity of a particle is determined by the following equation:

Circularity=Cs/Cp

wherein Cp represents the length of the circumference of a projected image of a particle and Cs represents the length of the circumference of a circle having the same area as that of the projected image of the particle.

The average circularity of a toner can be determined using a flow-type particle image analyzer FPIA-2000 manufactured by Sysmex Corp. A typical measurement method is as follows:
(1) 0.1 to 0.5 ml of a surfactant (preferably alkylbenzene sulfonate) is included as a dispersant in 100 to 150 ml of water from which solid impurities have been removed;
(2) 0.1 to 0.5 g of a toner is added thereto and dispersed using an ultrasonic dispersing machine for about 1 to 3 minutes to prepare a toner suspension liquid including 3,000 to 10,000 per 1 micro-liter of the toner particles; and
(3) the average circularity and circularity distribution of the toner are determined by the measuring instrument mentioned above.

The melting point of softening agents can be determined by detecting changes due to melting of crystals. For example, when a sample is subjected to a constant temperature change (typically heating), endothermic changes may be detected by a calorimeter and transmittance changes may be detected by an optical sensor or visual observation using a microscope.

Specifically, the melting point can be measured using a differential scanning calorimeter such as DSC-60 (from Shimadzu Corporation). First, an aluminum container is charged with about 5.0 mg of a sample and put on a holder unit. The holder unit is then set in an electric furnace, and heated from 20° C. to 150° C. at a heating rate of 10° C./min under nitrogen atmosphere. The resultant DSC curve is analyzed using an analysis program in the DSC-60 system so that the melting point of the sample is determined from an intersection of a baseline of the DSC curve and a tangent line of an endothermic peak.

The softening point (Tm) of resins and the like can be measured using a flow testing instrument CFT-500 (from Shimadzu Corporation). The softening point (Tm) can be defined as a temperature at which a half of a sample flows out. Measurement conditions are as follows, for example.

Sample quantity: 1.5 g

Die: having a diameter of 1.0 mm and a height of 1.0 mm

Heating rate: 3.0° C./min

Preheating time: 180 seconds

Load: 30 kg

Measuring temperature range: from 80 to 140° C.

The glass transition temperature (Tg) can be measured using a differential scanning calorimeter DSC-6220R (from Seiko Instruments Inc.). A sample maybe heated from room temperature to 150° C. at a heating rate of 10° C./min and kept at 150° C. for 10 minutes. The sample is then cooled to room temperature and left at rest for 10 minutes. Further, the sample is heated to 150° C. again at a heating rate of 10° C./min.

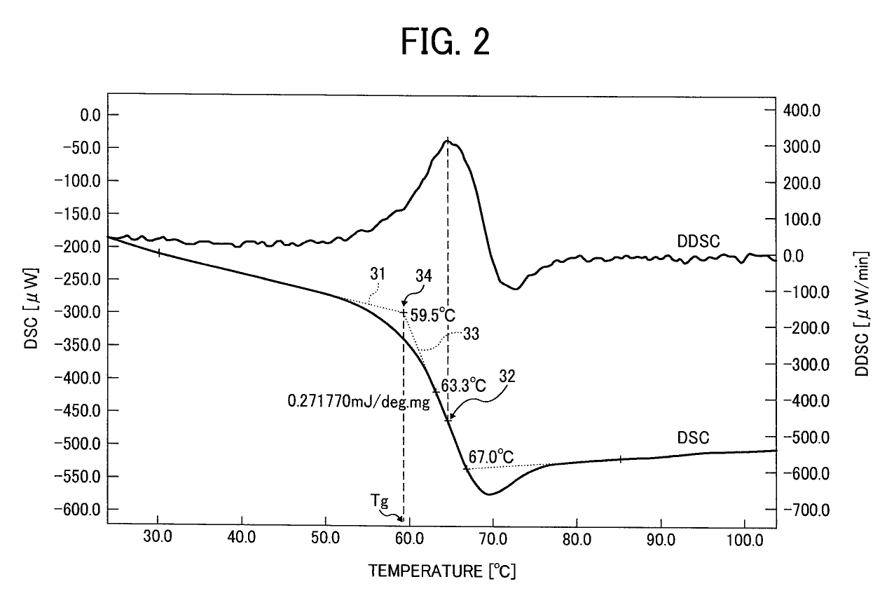

FIG. 2 is a graph for explaining how to determine the glass transition temperature. A baseline 31 is a tangent line of a DSC curve of the second heating within a range in which DDSC is 0±20 μm/min, which means glass transition is not yet occurring. A tangent line 33 is drawn from an inflection point 32 at which glass transition is occurring. The inflection point 32 corresponds to a peak of the DDSC curve. An intersection 34 of the baseline 31 and the tangent line 22 may be regarded as the glass transition temperature.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Toner Example 1

### Pulverization Toners

### Synthesis of Binder Resin A

A dropping funnel is charged with vinyl monomers including 600 g of styrene and 110 g of butyl acrylate, and a polymerization initiator including 30 g of dicumyl peroxide. Additionally, a 5-liter four-necked flask equipped with a thermometer, a stainless stirrer, a condenser, and a nitrogen inlet pipe is charged with polyester monomers including 1230 g of polyoxypropylene-2,2-bis(4-hydroxyphenyl)propane, 290 g of polyoxyethylene-2,2-bis(4-hydroxyphenyl)propane, 250 g of isododecenyl succinic anhydride, 310 g of terephthalic acid, and 180 g of 1,2,4-benzenetricarboxylic acid anhydride, an esterification catalyst including 7 g of dibutyltin oxide, and 340 g (i.e., 11.0 parts based on 100 parts of the polyester monomers) of a paraffin wax which has a melting point of 73.3° C. and a half-bandwidth of an endothermic peak of which is 4° C. measured in a temperature rising scan of a differential scanning calorimeter.

The above 5-liter four-necked flask containing the polyester monomer mixture is heated to 160° C. in a mantle heater while being agitated under nitrogen atmosphere. The vinyl monomer mixture in the dropping funnel is added to the 5-liter four-necked flask over a period of 1 hour. The resultant mixture is subjected to an addition polymerization reaction for 2 hours at 160° C., and subsequently to a condensation polymerization at 230° C. The polymerization degree of the resultant resin is traced by measuring the softening point using a constant load extrusive capillary rheometer such as a flow testing instrument CFT-500 described above, and the reaction is terminated when the resultant resin has a desired softening point. Thus, a binder resin A having a softening point of 130° C. is prepared. It should be noted that the binder resin A contains paraffin wax.

### Synthesis of Binder Resin B

A 5-liter four-necked flask equipped with a thermometer, a stainless stirrer, a condenser, and a nitrogen inlet pipe is charged with polyester monomers including 2210 g of polyoxypropylene-2,2-bis(4-hydroxyphenyl)propane, 850 g of terephthalic acid, and 120 g of 1,2,4-benzenetricarboxylic acid anhydride, and an esterification catalyst including 0.5 g of dibutyltin oxide. The above 5-liter four-necked flask containing the polyester monomer mixture is heated to 230° C. in a mantle heater under nitrogen atmosphere. The polymerization degree of the resultant resin is traced by measuring the softening point using a constant load extrusive capillary rheometer such as a flow testing instrument CFT-500 described above, and the reaction is terminated when the resultant resin has a desired softening point. Thus, a binder resin B having a softening point of 115° C. is prepared.

### Preparation of Cyan Toner 1C

A binder resin mixture in which the binder resins A and B are mixed at a weight ratio of 5:5 is prepared. 94 parts of the binder resin mixture, a cyan master batch containing 4 parts of a cyan colorant C. I. Pigment Blue 15:3, and 3 parts of a charge controlling agent (E-84 from Orient Chemical Industries, Ltd. which is a Zn complex of salicylic acid) are mixed so that the total amount becomes 3 kg. The mixture is further mixed in a 20-liter HENSCHEL MIXER for 5 minutes at a peripheral speed of 20 m/s, and is then melt-kneaded using a twin screw extruder (PCM-30 from Ikegai Co., Ltd.) from which a discharge part is removed. The melt-kneaded mixture is extended to have a thickness of 2 mm by applying pressure using a cooling press roller, and subsequently cooled using a cooling belt. The cooled mixture is pulverized into coarse particles using a feather mill, and the coarse particles are further pulverized using a mechanical pulverizer (KTM from Kawasaki Heavy Industries, Ltd.) so that the resultant particles have an average particle diameter of 10 to 12 μm. The particles are further pulverized and classified using a jet pulverizer (IDS from Nippon Pneumatic Mfg. Co., Ltd.) so that coarse particles are removed, and subsequently classified using a rotor classifier (110ATP from Hosokawa Micron Corporation) so that ultra-fine particles are removed. Thus, colored resin particles having a volume average particle diameter of 7.9 μm are prepared. 100 parts of the colored resin particles are mixed with 1 part of a silica (RX200 from Nippon Aerosil Co., Ltd.) using a HENSCHEL MIXER for 60 seconds at a peripheral speed of 40 m/sec. Thus, a cyan toner 1C is prepared.

### Preparation of Magenta Toner 1M

The procedure for preparation of the cyan toner 1C is repeated except that the cyan master batch is replaced with a magenta master batch containing 6 parts of a magenta colorant C. I. Pigment Red 269. Thus, a magenta toner 1M is prepared.

### Preparation of Yellow Toner 1Y

The procedure for preparation of the cyan toner 1C is repeated except that the cyan master batch is replaced with a yellow master batch containing 8 parts of a yellow colorant C. I. Pigment Yellow 180. Thus, a yellow toner 1Y is prepared.

### Toner Example 2

### Ester-Elongation Polymerization Toners

### Preparation of Polyester

A reaction vessel equipped with a condenser, a stirrer, and a nitrogen inlet pipe is charged with 553 parts of ethylene oxide 2 mol adduct of bisphenol A, 196 parts of propylene oxide 2 mol adduct of bisphenol A, 220 parts of terephthalic acid, 45 parts of adipic acid, and 2 parts of dibutyltin oxide. The mixture is subjected to a reaction for 8 hours at 230° C. under normal pressure, and subsequently for 5 hours under reduced pressures of 10 to 15 mmHg. Further, 46 parts of trimellitic anhydride are added thereto and the resultant mixture is subjected to a reaction for 2 hours at 180° C. under normal pressure. Thus, a polyester (1) is prepared. The polyester (1) has a number average molecular weight of 2,200, a weight average molecular weight of 5,600, a glass transition temperature of 43° C., and an acid value of 13.

### Preparation of Prepolymer

A reaction vessel equipped with a condenser, a stirrer, and a nitrogen inlet pipe is charged with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. The mixture is subjected to a reaction for 8 hours at 230° C. under normal pressure, and subsequently for 5 hours under reduced pressures of 10 to 15 mmHg. Thus, an intermediate polyester (1) is prepared. The intermediate polyester (1) has a number average molecular weight of 2,100, a weight average molecular weight of 9,500, a glass transition temperature of 55° C., an acid value of 0.5, and a hydroxyl value of 49.

Next, a reaction vessel equipped with a condenser, a stirrer, and a nitrogen inlet pipe is charged with 411 parts of the intermediate polyester (1), 89 parts of isophorone diisocyanate, and 500 parts of ethyl acetate. The mixture is subjected to a reaction for 5 hours at 100° C. Thus, a prepolymer (1) is prepared. The prepolymer (1) contains free isocyanates in an amount of 1.53% by weight.

### Preparation of Cyan Master Batch

First, 40 parts of a cyan colorant C. I. Pigment Blue 15:3, 60 parts of a polyester resin (RS-801 from Sanyo Chemical Industries having an acid value of 10, a weight average molecular weight of 20,000, and a glass transition temperature of 64° C.), and 30 parts of water are mixed using a HENSCHEL MIXER, resulting in a mixture in which water permeates pigment aggregation. The mixture is kneaded for 45 minutes using a twin roll kneader the surface temperature of which is set to 130° C. The kneaded mixture is then pulverized into particles having a diameter of 1 mm using a pulverizer. Thus, a master cyan batch (1) is prepared.

### Preparation of Colorant-Wax Dispersion

A vessel equipped with a stirrer and a thermometer is charged with 378 parts of the polyester (1), 120 parts of a paraffin wax (HNP9), and 1200 parts of ethyl acetate. The mixture is heated to 80° C. for 5 hours while being agitated, and subsequently cooled to 30° C. over a period of 1 hour. Further, 500 parts of the master batch (1) and 400 parts of ethyl acetate are added to the vessel and mixed for 1 hour. Thus, a raw material liquid (1) is prepared.

Next, 1500 parts of the raw material liquid (1) are subjected to a dispersion treatment using a bead mill (ULTRAVISCOMILL (trademark) from Aimex Co., Ltd.). The dispersing conditions are as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Further, 425.75 parts of the polyester (1) is added thereto and the mixture is subjected to the above dispersion treatment again for once (1 pass). Thus, a colorant-wax dispersion (1) is prepared. The colorant-wax dispersion (1) is diluted with 78 g of ethyl acetate so that the concentration of solid components becomes 50%.

### Preparation of Aqueous Medium

To prepare an aqueous medium, 953 parts of ion-exchange water, 88 parts of a 25% aqueous dispersion of an organic particulate resin (a copolymer of styrene, methacrylic acid, butyl acrylate, and sodium salt of sulfate ester of ethylene oxide adduct of methacrylic acid), 90 parts of a 48.5% aqueous solution of dodecyl diphenyl ether sodium disulfonate (ELEMINOL MON-7 from Sanyo Chemical Industries, Ltd.), and 113 parts of ethyl acetate are mixed. Thus, an aqueous medium (1), which is a milky liquid, is prepared.

### Emulsification

First, 967 parts of the colorant-wax dispersion (1), 14 parts of a charge control agent (E-84 from Orient Chemical Industries, Ltd. which is a Zn complex of salicylic acid), and 6 parts of isophorone diamine are mixed for 1 minute using TK HOMOMIXER (from PRIMIX Corporation) at a revolution of 5,000 rpm. Next, 137 parts of the prepolymer (1) is further added and mixed for 1 minute using TK HOMOMIXER (from PRIMIX Corporation) at a revolution of 5,000 rpm. The resultant mixture is poured into 1,200 parts of the aqueous medium and is agitated by TK HOMOMIXER at a revolution of 8,000 to 13,000 rpm for 20 minutes. Thus, an emulsion slurry (1) is prepared.

### Solvent Removal

The emulsion slurry (1) is poured into a vessel equipped with a stirrer and a thermometer and subjected to a solvent removal for 8 hours at 30° C. Thus, a dispersion slurry (1) is prepared.

### Washing and Drying

Next, 100 parts of the dispersion slurry (1) is filtered under a reduced pressure to obtain a wet cake.

The wet cake thus obtained is mixed with 100 parts of ion-exchange water and the mixture is agitated for 10 minutes using a TK HOMOMIXER at a revolution of 12,000 rpm, followed by filtering. Thus, a wet cake (i) is prepared.

The wet cake (i) is mixed with 900 parts of ion-exchange water and the mixture is agitated for 30 minutes using a TK HOMOMIXER at a revolution of 12,000 rpm while applying ultrasonic vibration, followed by filtering under a reduced pressure. This operation is repeated until the re-slurry liquid has an electric conductivity of 10 μC/cm or less. Thus, a wet cake (ii) is prepared.

The wet cake (ii) is mixed with a 10% aqueous solution of hydrochloric acid so that the re-slurry liquid has a pH is 4. Thus, a wet cake (iii) is prepared.

The wet cake (iii) is mixed with 100 parts of ion-exchange water and the mixture is agitated for 10 minutes using a TK HOMOMIXER at a revolution of 12,000 rpm, followed by filtering. This operation is repeated until the re-slurry liquid has an electric conductivity of 10 μC/cm or less. Thus, a wet cake (iv) is prepared.

The wet cake (iv) is dried for 48 hours at 45° C. using a circulating air drier, followed by sieving with a screen having openings of 75 μm. Thus, a mother toner (1) is prepared. The mother toner (1) has a volume average particle diameter (Dv) of 5.8 μm, a number average particle diameter (Dp) of 5.2 μm, a ratio Dv/Dp of 1.12, and an average circularity of 0.973.

Next, 100 parts of the mother toner and 0.5 part of a hydrophobized silica are mixed using a HENSCHEL MIXER. Thus, a cyan toner 2C is prepared.

### Preparation of Magenta Toner 2M

The procedure for preparation of the cyan toner 2C is repeated except that the cyan master batch (1) is replaced with a magenta master batch containing 5 parts of a magenta colorant C. I. Pigment Red 184. Thus, a magenta toner 2M is prepared.

### Preparation of Yellow Toner 2Y

The procedure for preparation of the cyan toner 2C is repeated except that the cyan master batch (1) is replaced with a yellow master batch containing 5.5 parts of a yellow colorant C. I. Pigment Red 155. Thus, a yellow toner 2Y is prepared.

### Examples 1 to 15

The above-prepared toners 2C, 2M, and 2Y are subjected to the following evaluations.

### Preparation of Gloss Control Particle

The procedure for preparation of the cyan toner 2C is repeated except that the cyan colorant in the cyan master batch (1) is replaced with softening agents described in Tables 1 and 2.

### Evaluation of Gloss

A black toner cartridge of IPSIO CX2500 (from Ricoh Co., Ltd.) is filled with each of the gloss control particles prepared above. A red solid image in which 0.5 mg/cm² of a yellow toner layer and 0.5 mg/cm² of a magenta toner layer are deposited and a cyan solid image in which 0.5 mg/cm² of a cyan toner layer each having a width of 1 cm are adjacently and alternately formed on a copier paper (TYPE6000-70W from Ricoh Co., Ltd.). Further, a solid image composed of the gloss control particle is formed thereon to form a gloss control layer. The amounts of the deposited gloss control particles are described in Table 1. Each of the images thus prepared is fixed when the fixing roller has a surface temperature of 160° C., and the gloss thereof is measured using a gloss meter (from Nippon Denshoku Industries Co., Ltd.) at an incident angle of 60°.

### Evaluation of Stress Resistance

Each of the toners prepared above and the gloss control particles are set in IPSIO CX2500 (from Ricoh Co., Ltd.) and a print pattern in which a ratio of image portions to non-image portions is 6% is continuously produced on sheets at 23° C. and 45% RH. After 50^{th} and 2,000^{th} sheets are produced, the developing roller is observed to determine whether or not the gloss control layer forms undesirable linear adhesion thereon, and the level is graded as follows.

A: No linear adhesion is observed.

B: A couple of linear adhesions are observed on an end.

C: A lot of linear adhesions are observed.

### Example 16

The procedure in Example 3 is repeated except that the toners 2C, 2M, and 2Y are replaced with the toners 1C, 1M, and 1Y.

### Comparative Example 1

The procedure in Example 1 is repeated except that no gloss control particle is used.

### Comparative Example 2

The procedure in Example 1 is repeated except that no softening agent is included in the master batch.

### Comparative Example 3

The procedure in Example 1 is repeated except that 0.5% by weight of the softening agent in the master batch is replaced with 10% by weight of bis(2-ethylhexyl)phthalate (DOP) which is a liquid having a pour point of −55° C.

TABLE 1

| | Gloss Control Particle | | | | | | Stress |
|---|---|---|---|---|---|---|---|
| | Softening Agent | | | | | | Resistance |
| | | Amount | Deposition | Gloss of Image | | | Linear |
| | | (% by | Amount | Red | Cyan | Non-image | Adhesion |
| | Compound | weight) | (mg/cm²) | Portion | Portion | Portion | Level |
| Ex. 1 | S1 | 0.5 | 0.5 | 20 | 17 | 15 | A |
| Ex. 2 | S1 | 2 | 0.5 | 24 | 22 | 20 | A |
| Ex. 3 | S1 | 10 | 0.5 | 34 | 33 | 31 | A |
| Ex. 4 | S1 | 20 | 0.5 | 40 | 39 | 38 | A |
| Ex. 5 | S1 | 30 | 0.5 | 50 | 47 | 47 | B |
| Ex. 6 | S1 | 20 | 0.3 | 32 | 30 | 27 | A |
| Ex. 7 | S1 | 20 | 0.7 | 52 | 51 | 50 | A |
| Ex. 8 | S1 | 20 | 1 | 60 | 59 | 59 | A |
| Ex. 9 | S1 | 20 | 1.2 | 70 | 70 | 70 | A |
| Ex. 10 | S2 | 20 | 0.5 | 39 | 38 | 36 | A |
| Ex. 11 | S2 | 30 | 0.5 | 48 | 45 | 45 | A |
| Ex. 12 | S3 | 20 | 0.5 | 39 | 37 | 35 | A |
| Ex. 13 | S3 | 30 | 0.5 | 47 | 45 | 43 | A |
| Ex. 14 | S1 + S2 | 10 + 10 | 0.5 | 37 | 36 | 34 | A |
| Ex. 15 | S1 + S3 | 10 + 10 | 0.5 | 37 | 36 | 34 | A |
| Ex. 16 | S1 | 10 | 0.5 | 27 | 26 | 23 | B |
| Comp. | Not used | | | 15 | 7 | 2 | — |
| Ex. 1 | | | | | | | |
| Comp. | 0 | 0 | 0.5 | 15 | 11 | 10 | A |
| Ex. 2 | | | | | | | |
| Comp. | DOP* | 10 | 0.5 | 20** | 20** | 15** | C |
| Ex. 3 | | | | | | | |

*DOP: Bis(2-ethylhexyl)phthalate
**Offset to the fixing member occurs.

TABLE 2

| Compound | | Melting Point |
|---|---|---|
| Number | Compound Name | (° C.) |
| S1 | Hydroxystearic acid | 75 |
| S2 | N-Hydroxyethyl-12-hydroxystearylamide | 105 |
| S3 | N,N′-Ethylenebis-oleylamide | 114 |

In the present invention, pulverization toners maybe less smooth than ester-elongation polymerization toners because of their large particle size and irregular shape.

Further, the present invention gloss control particle provides images having high gloss, in part due to the presence of the softening agent in the gloss control particle.

This document claims priority and contains subject matter related to Japanese Patent Application No. 2008-061979, filed on Mar. 12, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A gloss control particle, comprising:
a binder resin; and
a softening agent configured to soften the binder resin upon application of heat;
wherein the gloss control particle is configured to form a transparent and colorless gloss control layer on a colored toner image which is to be fixed on a recording medium upon application of heat.

2. The gloss control particle according to claim 1, wherein the softening agent has a melting point of not greater than a fixing temperature at which the colored toner image is fixed on a recording medium.

3. The gloss control particle according to claim 1, wherein the softening agent has a melting point of from 40 to 140° C. and at least one of a carboxylic acid group and an amide bond group.

4. A developer set, comprising:
a developer comprising at least one colored toner; wherein the at least one colored toner comprises a binder resin and a colorant; and
the gloss control particle according to claim 1.

5. The developer set according to claim 4, wherein the at least one colored toner comprises one each of a magenta toner, a cyan toner and a yellow toner.

6. The developer set according to claim 5, wherein the at least one colored toner further comprises a black toner.

7. The developer set according to claim 4, wherein the binder resin of the gloss control particle and the binder resin of the at least one colored toner are the same.

8. The developer set according to claim 4, wherein at least one of the binder resins included in the gloss control particle and the at least one colored toner comprises a polyester resin.

9. The developer set according to claim 8, wherein the polyester resin has a glass transition temperature of 40 to 80° C.

10. The developer set according to claim 8, wherein the polyester resin is a modified polyester resin.

11. The developer set according to claim 10, wherein the modified polyester resin has a urethane group.

12. The developer set according to claim 10, wherein the modified polyester resin is prepared by reacting a polyester resin having a terminal isocyanate group with an amine.

13. The developer set according to claim 4, wherein the developer is a one-component developer containing no magnetic carrier.

14. An image forming method, comprising:
forming an electrostatic latent image on an electrostatic latent image bearing member;
developing the electrostatic latent image with a developer to form a toner image;
transferring the toner image onto a recording medium; and
fixing the toner image on the recoding medium upon application of heat,
wherein the developer is the developer set according to claim 4 so that a gloss control layer is formed on the recording medium as an outermost layer.

15. An image forming method, comprising:
forming an electrostatic latent image on an electrostatic latent image bearing member;
developing the electrostatic latent image with a developer to form a toner image;
transferring the toner image onto a recording medium; and
fixing the toner image on the recoding medium upon application of heat,
wherein the developer is the developer set according to claim 5, so that a gloss control layer is formed on the recording medium as an outermost layer.

16. An image forming method, comprising:
forming an electrostatic latent image on an electrostatic latent image bearing member;
developing the electrostatic latent image with a developer to form a toner image;
transferring the toner image onto a recording medium; and
fixing the toner image on the recoding medium upon application of heat,
wherein the developer is the developer set according to claim 6, so that a gloss control layer is formed on the recording medium as an outermost layer.

17. The image forming method according to claim 14, wherein the developing comprises:
forming a developer layer having a predetermined thickness on a developer bearing member by a developer layer control member so that the developer layer develops the electrostatic latent image formed on the electrostatic latent image bearing member.

18. The image forming method according to claim 14, wherein at least one of the binder resins included in the gloss control particle and the at least one colored toner comprises a polyester resin.

19. The image forming method according to claim 18, wherein the polyester resin is a modified polyester resin.

20. The image forming method according to claim 19, wherein the modified polyester resin has a urethane group.
